(19) United States
(12) Patent Application Publication
(10) Pub. No.: US 2002/0188716 A1
(43) Pub. Date: Dec. 12, 2002

(54) System and method for implementing a communication profiler

(75) Inventor: Kraig A. Bottemiller, Rochester, MN (US)

Correspondence Address: BRACEWELL & PATTERSON, L.L.P., SUITE 350, 7600B NORTH CAPITAL OF TEXAS HWY., AUSTIN, TX, 78731-1168, US

(73) Assignee: International Business Machines Corporation

(21) Appl. No.: 09/876,379

(22) Filed: Jun. 7, 2001

(51) Int. Cl. G06F 15/16; G06F 15/173

(52) U.S. Cl. 709/224; 709/230

(57) ABSTRACT

A system and method for recording and transmitting data concerning hardware performance in data processing systems. A host system includes a host processor, a data processing element and a host system memory coupled via a host interconnect. The data processing element includes multiple master elements, multiple slave elements, a system interconnect, and a communication profiler. A determination is made if the received address a valid primary or secondary address. Then, if a valid primary or secondary address is received, data are stored in a memory system and the transaction timer is set and started. If the present operation is considered secondary, the present operation is held until the primary operation is complete. When the primary operation is completed, the secondary operation is now designated a primary operation. Then, the transaction timer is turned off when the data transfer operation ends. The data are then serialized and transmitted. The operation then returns to its starting state.

### BACKGROUND OF THE INVENTION

1. Technical Field

The present invention relates in general to the field of data processing systems, and in particular, to profiling data processing systems. Still more particularly, the present invention relates to a method and system for recording and transmitting data concerning system performance.

2. Description of the Related Art

Profiling is a technique commonly used by software developers to gather information about the operation of their code. Such information can then be used for code improvement. A profiler adds monitoring code to the executable file so that the monitoring code records various types of statistical data during the program execution. The type of data recorded depends on the profiler being used.

One traditional and widely used profiler for the UNIX operating system is known as prof. Object code files are supplied to prof, which links the object code files and adds monitoring routines to the beginning and the end of a program. The initial routines set up a program sampler triggered by timing interrupts. The program sampler, which is invoked at intervals of 1/100 of a second, records the value of a program counter register. The routines added to the end of the program take the recorded information and generate an output file showing the execution time consumed by the various routines. The output file can be presented in the form of a histogram.

The aforementioned information can be useful to a programmer by indicating which routine consumes the most execution time and may therefore be a candidate for optimization. However, the profiler prof suffers from a number of limitations: prof requires operating system (“OS”) support for its interrupts; prof also identifies where the execution is at the sampling times, but does not identify the call chain that led to the current function being called; and prof relies on timed interrupts with a 1/100 second sampling interval. This lengthy interval causes sampling errors because with today's fast processing speeds, many instructions or even complete routines can be executed in 1/100 of a second. The execution of short routines can therefore go entirely undetected by prof, and sampling errors can cause significant inaccuracies in the measured execution times even for longer routines. The 1/100 sampling interval could be theoretically shortened, but decreasing the sampling interval has been found to add excessive overhead. Prof implementations therefore generally do not allow “tuning” of the sampling rate. Furthermore, because the timing interrupts that trigger the sampling mechanism are not generated during OS function calls, OS function calls appear “free” under prof, whereas they actually might be responsible for a majority of the total execution time.

Another commonly used profiler, known as gprof, relies on recompilation of source code to add more monitoring features than those present in prof. In addition to the interrupt sampling performed by prof, gprof adds code to the beginning of each function that performs a call to gprof. A significant problem arises, however, if the program employs library code for which source files are unavailable. The profiler gprof is then unable to process the functions defined in these files, and the function callers cannot then be recorded. When the execution sequence passes into one of these unmonitored functions, the call trace is severed. If the unmonitored function initiates calls that lead back into a monitored function, such calling of the monitored function will be disconnected from the remainder of the call trace. Such situations are termed “spontaneous function calls.”

The main disadvantage of the aforementioned profiling methods is that the system is perturbed during the analysis. By adding extra code to the program to be analyzed, software overhead is added, and the performance of the system is decreased. Also, conventional profiling methods only provide information on how much execution time 5 each routine consumes, but provides no information about actual bus transfer speeds or other hardware information. In addition, software implementations of profilers require extra operating system and compiler support options that are not typically available in embedded or system-on-a-chip systems. Hardware designers frequently require information regarding bus utilization, probability of contention, bottlenecks, and the use of resources. Such data cannot be accurately gathered using traditional software profiling methods due the performance decrease suffered from implementing the extra profiling code.

Still another method for system monitoring that is well-known to those skilled in the art involves connecting an analyzer to a processor bus. Because system monitoring with an analyzer adds no software overhead, a more accurate picture of system operation can be obtained. However, using an analyzer for system monitoring can be cost prohibitive because a conventional direct connection to a system bus can require forty or more wire connections. Also, the sheer amount of data collected can be difficult to sort to retrieve the relevant data. System monitoring with an analyzer is also limited generally to systems that utilize discrete components and would be extremely difficult to use to monitor a configuration such as a system-on-a-chip due to the numerous required wire connections.

### SUMMARY OF THE INVENTION

To overcome the foregoing and additional limitations in the prior art, a data processing element for use in a host system according to the present invention includes a processor, a system memory, multiple peripherals, and a communication profiler. The communication profiler includes a control unit, a transaction timer, a local memory, a data serializer/transmitter, and an output port. The output port is connected to an external analyzer. The control unit directs the capture of a set of data deemed useful by a user of the present invention. The data set is stored in the local memory until the data are serially transmitted via the output port to an external analyzer. When activated, the communication profiler samples, summarizes, and transmits information taken from interactions between the system processor and other components of the host system.

In a method of communication profiling according to the present invention, a determination is made if a valid address has been received. If a valid address is received, the control unit is activated, sampling relevant data and storing sampled data in a local memory. A transaction timer is set and started. If the present operation is considered secondary, the present operation is held until a higher priority primary operation completes. When the primary operation completes, the secondary operation is then designated a primary operation. The transaction timer is disabled when all relevant operations end. The sampled data are then serialized and transmitted.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a pictorial representation of a host data processing system, including a host interconnect, a host memory system, a host processor, and multiple peripherals, which may be utilized to implement the present invention;

FIG. 2 depicts a data processing system that includes a system interconnect, a communication profiler, and multiple master and slave elements in accordance with a preferred embodiment of the present invention;

FIG. 3 illustrates a detailed depiction of a communication profiler that includes a transaction timer, a profiler interconnect, a control unit, a local memory, a data serializer/transmitter, an input port, an output port, a control register, and external connections in accordance with a preferred embodiment of the present invention;

FIG. 4 depicts a detailed illustration of a communication summary table in a local memory structure of the communication profiler in accordance to a preferred embodiment of the present invention; and

FIG. 5 is a high-level logic flow chart of a method of gathering hardware performance data from a data processing system implemented as a system-on-a-chip element in accordance with a preferred embodiment of the present invention.

### DETAILED DESCRIPTION OF THE PREFERRED EMBODIMENT

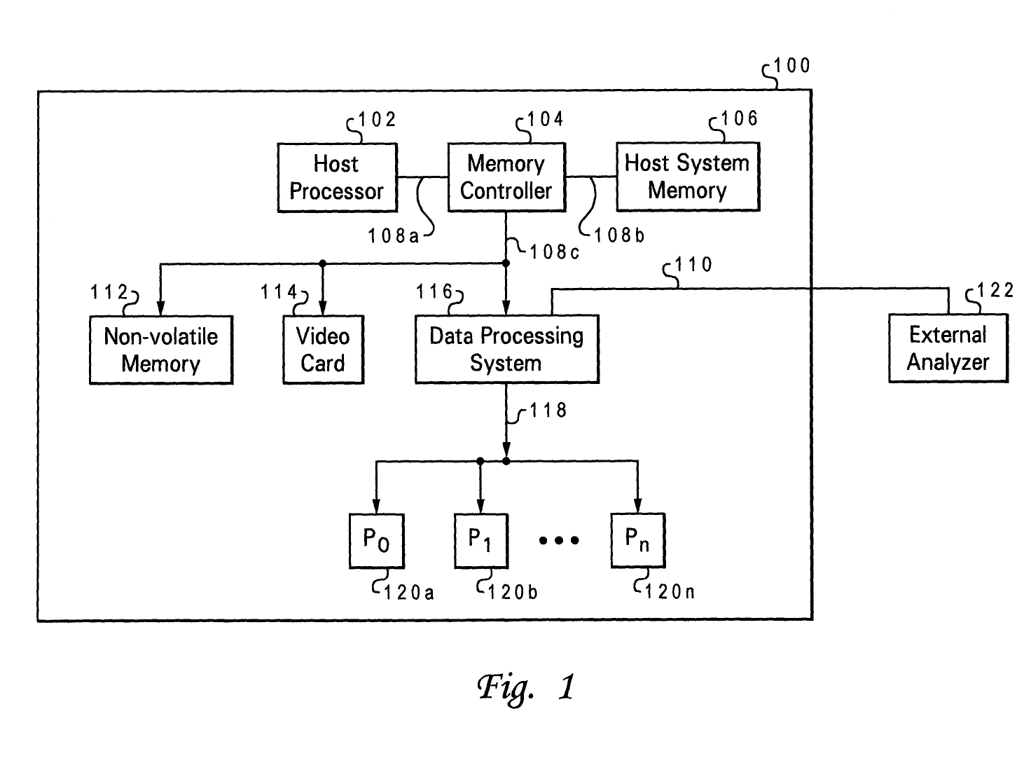

With reference now to the figures, and in particular with reference to FIG. 1, there is depicted a host system 100 including a host processor 102 coupled to a memory controller 104 by a host interconnect 108a. Further coupling memory controller 104 to host system memory 106 is a host interconnect 108b. A host interconnect 108c couples a non-volatile memory 112, a video card 114, and a data processing system 116. According to a preferred embodiment of the present invention, data processing system 116 can be implemented as a small computer system interface (SCSI) controller and is coupled to multiple peripherals 120a-120n through a secondary interconnect 118. These peripherals 120a-120n can be implemented as a magnetic storage device, or any other device is compatible with the SCSI standard. An analyzer interconnect 110 couples data processing system 116 to external analyzer 122.

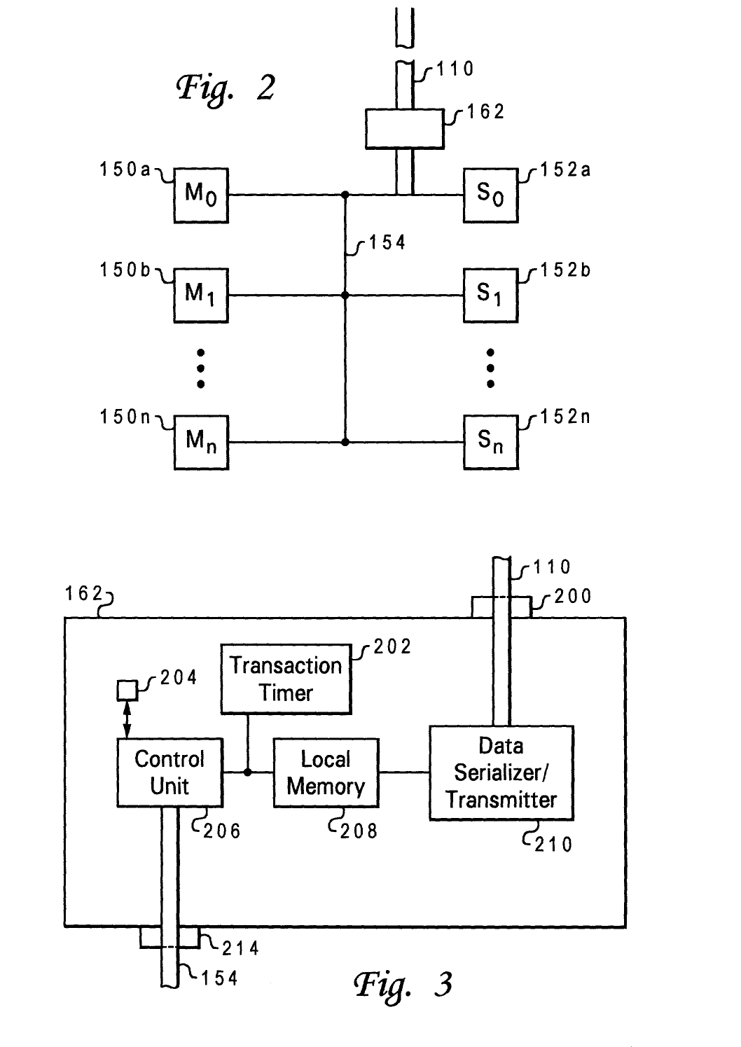

Referring now to FIG. 2, a more detailed view of data processing system 116 is illustrated. Data processing system 116 includes a communication profiler 162, multiple master elements 150a-150n, and multiple slave elements 152a-152n all coupled to system interconnect 154. Master elements 150a-150n can be implemented as any type of controller device. For example, a processor 150a can be considered a master element. Slave elements 152a-152n can be implemented as memory, or any other type of controlled device. Those skilled in the art should appreciate that system interconnect 154 can be implemented using a bus, switch, or any other type of coupling means.

Communication profiler 162 monitors system interconnect 154 for tenures of interest initiated by either master elements 150a-150n or slave elements 152a-152n. As described below in detail, communication profiler 162 captures selected data from the tenures and communicates the captured data, via analyzer interconnect 110, to external analyzer 122.

According to a preferred embodiment of the present invention, data processing system 116 can be implemented on a single integrated circuit substrate. This configuration is well-known in the art as a “system-on-a-chip” (SOC) implementation. An SOC typically includes several complex circuit blocks, or modules, within the bounds of a single integrated circuit substrate. The basic concept behind SOC design involves placing logic cores or memory macros in an integrated circuit substrate much the same way shelf components are placed on printed circuit boards, then adding memory, logic, and data path or interconnect coupling in order to implement system level integration. SOC's address the need for higher chip densities and permit more data processing system functionality such as audio, video, and graphics, which have typically been coupled to a processor at the card level, to be integrated into a single integrated circuit substrate.

With reference now to FIG. 3, a more detailed illustration of communication profiler 162 is depicted. In the following description of a preferred embodiment of communication profiler 162, reference will be made to “tenures” and “operations.” As utilized herein, a “tenure” is defined as a continuous transmission of data including instructions over an interconnect by an initiator. Some examples of tenures are: requests, responses, and data transfers between master elements 150a-150n and slave elements 152a-152n. An “operation” by contrast, is defined as one or more tenures including a request tenure and associated action(s) by master elements 150a-150n or slave elements 150a-150n utilized to service the request tenure. As shown in FIG. 3, communication profiler 162 has an input port 214 coupled to system interconnect 154 and an output port 200 coupled to analyzer interconnect 110. In addition, communication profiler contains a control unit 206 that monitors tenures on system interconnect 154 and filters the tenure data for selected data of interest in response to settings of a control register 204. Control unit 206 is coupled to transaction timer 202 that can be utilized to recode the duration of a pending operation monitored on system interconnect 154. A local memory 208 coupled to control unit 206 stores the filtered data obtained by control unit 206. Coupled to local memory 208 is data serializer/transmitter 210, which translates filtered data from parallel to serial format and transmits the data via output port 200 and analyzer interconnect 110 to external analyzer 122. Because of the serialization of the monitoring data by data serializer/transmitter 210, communication profiler 162 can advantageously be coupled to external analyzer 122 through a single wire connection, thus providing a significant advantage over the prior art implementations, which often required over forty wire connections.

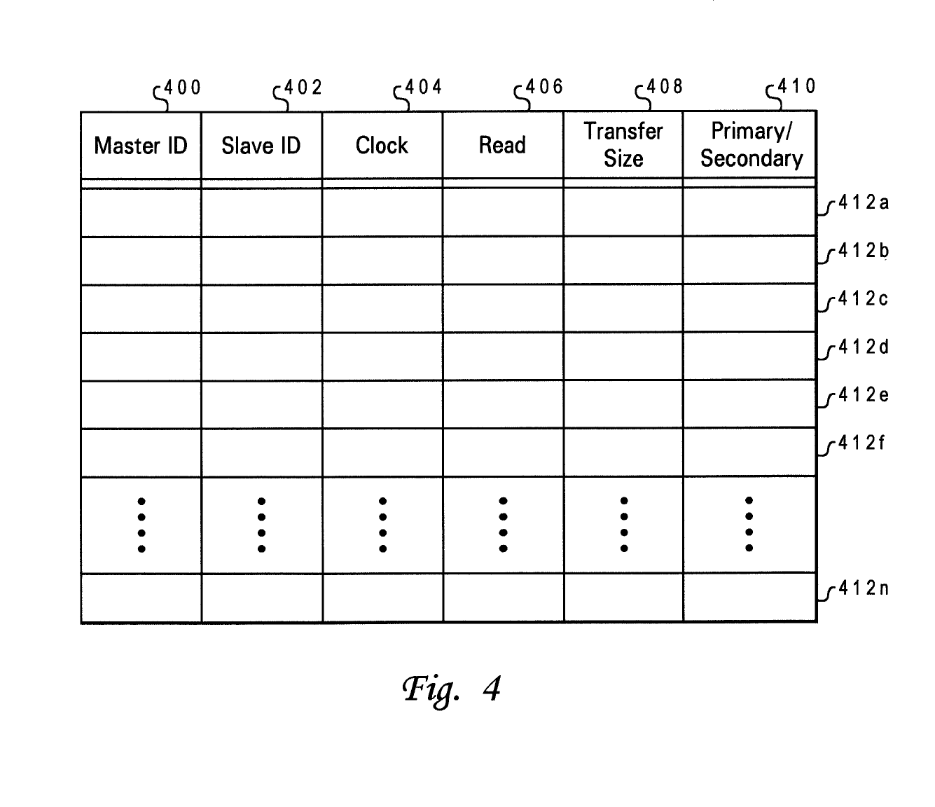

With reference to FIG. 4, there is depicted a more detailed illustration of a table within local memory 208 containing multiple entries 412a-412n that each contain data characterizing at least one tenure monitored by communication profiler 162 over system interconnect 154. Master identification (ID) field 400 stores data that identify which one of master elements 150a-150n is participating in the tenure. Slave ID field 402 similarly contains data indicating which one of the multiple slave elements 152a-152n in data processing system 116 is participating in the tenure. A duration of an operation is stored in clock field 404. The size of the data transferred by the tenure is stored in transfer size field 408. Read field 406 stores an indication of whether or not the present tenure requests a read operation. Finally, primary/secondary 410 field indicates whether the tenure is a blocked (secondary) or a non-blocked (primary) operation, as explained later in more detail. Table entries 412a-412n include filtered data from individual tenures.

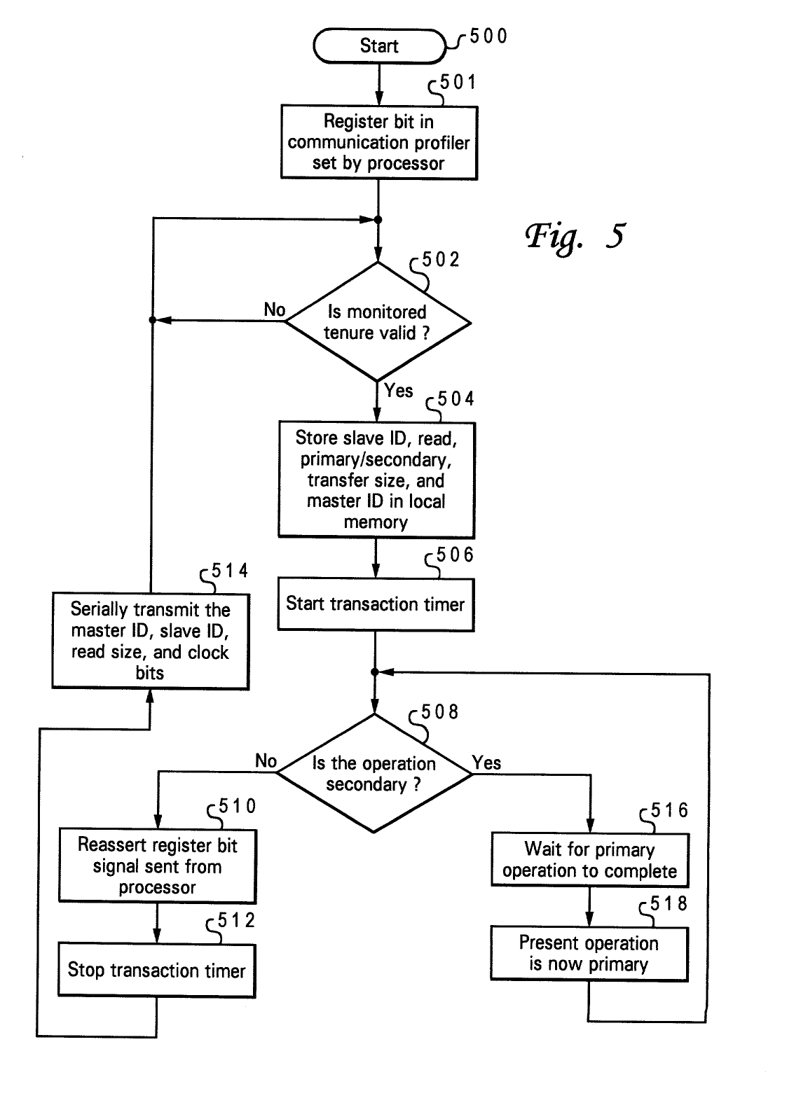

With reference to FIG. 5, a logic flowchart illustrating a preferred method of communication profiling according to the present invention is depicted. A preferred embodiment of the present invention can implement the communication profiling method utilizing logic circuitry within control unit 206.

As illustrated, the process begins at block 500 and then continues to block 501, which illustrates processor 150a setting control register 204 to activate communication profiler 162. Communication profiler 162 then monitors system interconnect 154 for a selected set of tenures. Next at block 502, a determination is made whether or not a tenure of interest is valid. If the monitored tenure is not valid, the procedure iterates at block 502, as illustrated. If the monitored tenure is valid, the process continues to block 504, which illustrates control unit 206 storing information filtered from the tenure within master ID field 400, slave ID field 402, read field 406, transfer size 408, and s primary/secondary field 410 in local memory 206. The transaction timer is also reset and started, as depicted at block 506.

Next, the process moves to block 508, which illustrates control unit 206 determining whether or not the operation specified by the tenure is a secondary operation. 10 A primary or non-blocked operation is an operation for which processor 150a has direct access to a component via a system interconnect 154. A secondary or blocked operation is an operation blocked by another operation on the system interconnect 154 targeting the same slave component 152. The primary/secondary operation scheme introduces a two-tiered priority scheme in which operations that cannot be executed immediately are designated as secondary operations. In response to a determination that the tenure represents a secondary operation, the process continues to block 516, which depicts the processing of the secondary operation waiting on completion of the primary operation. As illustrated at block 518, following completion of the primary operation, the secondary operation is then designated as a primary operation. The process returns to block 508, and then, since the snooped operation is no longer considered a secondary operation, the process continues to block 510.

Block 510 depicts processor 150a sending a signal to reset control register 204 upon completion of the operation, thus halting the monitoring performed by communication profiler 162. As illustrated in block 512, transaction timer 202 is stopped when the monitoring process of communication profiler 162 ends. Control unit 206 then stores the duration measured by transaction timer 202 in clock field 404. The data stored in local memory 208 which summarizes the monitored tenure may then be serialized and transmitted by data serializer/transmitter 210, as depicted in block 514. The process thereafter returns from block 514 to block 502, and processing continues. Thus, communication profiler 162, when activated, monitors a system interconnect for a specific set of tenures and filters data received from the specific set of tenures for data requested by the user. The data requested by the user is then saved in a local profiler memory in summary form and transmitted without perturbing the operation of the data operating system 116. This is accomplished because there is no software overhead in this preferred embodiment of the present invention.

As described above, an improved system and method of implementing a communication profiler is presented. A communication profiler, as implemented according to a preferred embodiment of the present invention, monitors a data processing system (e.g., a SOC) for specific valid tenures between a master element and a slave element. If a monitored tenure is deemed valid, a control unit is utilized to filter specific data from the monitored tenure. This specific data is stored in a local memory as a tenure summary and then transmitted to an external analyzer. An advantage of the present invention is that specific data are filtered from a monitored tenure by the communication profiler. Thus, a user may gather only the needed hardware performance data from a predefined set of tenures. Also, the hardware performance data gathered is more representative of the actual performance of the data processing system because the communication profiler filters data without perturbing the operation of the data processing system during the monitoring process.

While the invention has been particularly shown and described with reference to a preferred embodiment, it will be understood by those skilled in the art that various changes in form and detail may be made therein without departing from the spirit and scope of the invention.

What is claimed is:

1. A communication profiler, for use with a data processing system including a processor and a memory coupled by a system interconnect, wherein said communication profiler comprises:
a control unit including an input port coupled to said system interconnect, wherein said control unit receives a collection of data via said input port as a result of a tenure on said system interconnect, wherein said control unit filters said collection of data from said tenure to obtain specific data requested by a user and organizes said specific data as a summary.

2. The communication profiler according to claim 1, further comprising:
a profiler interconnect; and
a profiler memory, coupled to said profiler interconnect, wherein said profiler memory stores said summary.

3. The communication profiler according to claim 1, further including:
an output port that can be coupled to an external analyzer to communicate said summary.

4. The communication profiler according to claim 1, further comprising:
a control register, coupled to said control unit, which activates filtering of said collection of data by said control unit.

5. The communication profiler according to claim 1, further including:
a transaction timer, coupled to said control unit, wherein said transaction timer is utilized to record a duration of a operation pending.

6. The communication profiler according to claim 1, further comprising:
a data serializing and transmitting device that serially outputs said summary from said communication profiler, wherein said summary is indicative of normal hardware performance.

7. A data processing system, comprising:
a system interconnect;
a plurality of master elements, coupled to said system interconnect;
a plurality of slave elements, coupled to said system interconnect; and
a communication profiler, coupled to said system interconnect, further including:
a control unit including an input port coupled to said system interconnect, wherein said control unit receives a collection of data via said input port as a result of a tenure between a master element and a slave element on said system interconnect, wherein said control unit filters said collection of data from said tenure and retrieves a set of specific data requested by a user and organizes said set of specific data as a summary.

8. The data processing system according to claim 7, wherein said data processing system is a small computer system interface (SCSI) controller.

9. The data processing system according to claim 7, wherein said data processing system is implemented on a single integrated circuit substrate.

10. A host data processing system comprising:
a host interconnect;
a host processor coupled to said host interconnect;
a host memory coupled to said host interconnect;
a data processing system including a processor and memory coupled by a system interconnect comprising:
a plurality of master elements, coupled to said system interconnect;
a plurality of slave elements, coupled to said system interconnect; and
a communication profiler, coupled to said system interconnect, further including:
a control unit including an input port coupled to said system interconnect, wherein said control unit receives a collection of data via said input port as a result of a tenure between a master element and a slave element on said system interconnect, wherein said control unit filters said collection of data from said tenure and retrieves a set of specific data requested by a user and organizes said set of specific data as a summary.

11. The host data processing system according to claim 10, further comprising:
a memory controller, coupled to said host interconnect, utilized to control said host memory.

12. A method for gathering hardware performance data, comprising the steps of:
activating a communication profiler coupled to a system interconnect by setting a control register, coupled to a control unit in said communication profiler;
monitoring a system interconnect for a tenure between a master element and a slave element of a data processing system; and
capturing a set of data resulting from said tenure and organizing said set of data into a summary, in response to detecting a tenure on said system interconnect.

13. The method for gathering hardware performance data according to claim 12, further comprising the step of:
deactivating said communication profiler, by resetting said control register.

14. The method for gathering hardware performance data according to claim 12, further comprising the step of:
transmitting said summary to an external analyzer.
